(19) United States
(12) Patent Application Publication
(10) Pub. No.: US 2014/0229809 A1
(43) Pub. Date: Aug. 14, 2014

(54) ELECTRONIC MAGAZINE GENERATION SYSTEM, ELECTRONIC MAGAZINE GENERATION METHOD, AND ELECTRONIC MAGAZINE GENERATION PROGRAM

(71) Applicant: papelook Inc., Yokohama-shi (JP)

(72) Inventors: Kazuhiro Matsuura, Yokohama-shi (JP); Ichiro Ozawa, Yokohama-shi (JP)

(73) Assignee: papelook Inc., Yokohama-shi (JP)

(21) Appl. No.: 14/181,092

(22) Filed: Feb. 14, 2014

(30) Foreign Application Priority Data
Feb. 14, 2013 (JP) 2013-026668

(51) Int. Cl. G06F 17/21

(52) U.S. Cl. CPC G06F 17/211; G06F 17/214
USPC 715/202

(57) ABSTRACT

An electronic magazine generation system includes an original information division recording unit which records a plurality of sorting information pieces into which each piece of original information for generating a plurality of magazines is divided in the unit of themes, a main page creation unit which controls display sizes of the main image and the related image and font sizes of text information and text string as size information in accordance with a display region of a display apparatus, and creates a main page in which the main image and the text string are arranged on a background image on the basis of controlled correspondence information, and a detailed information page creation unit which creates a detailed information page for displaying a related image of a selected main image and text information having correspondence information with the related image when the main image is selected by the user on the main page.

### BACKGROUND OF THE INVENTION

1. Field of the Invention

The present invention relates to an electronic magazine generation system, an electronic magazine generation method, and an electronic magazine generation program, and particularly to an electronic magazine generation system, an electronic magazine generation method, and an electronic magazine generation program capable of generating an electronic magazine for being displayed on a display apparatus.

2. Background Art

In recent years, display apparatuses such as portable terminals including smart phones and tablet computers and digital home appliances have been widely used. Along therewith, a service for viewing an electronic document by using the display apparatus such as a portable terminal has been provided. However, in a case where a book which is a paper medium such as a magazine is converted into an electronic magazine, a system of the related art generating an electronic document reduces a resolution thereof so as to match a display region of the portable terminal. In addition, among electronic magazine generation systems of the related art, there are ones which ensure visibility and operability by changing a font size of text so as to match a size of a display in a case of an electronic magazine which represents text of a fiction or the like.

Japanese Unexamined Patent Application Publication No. 2012-141702 discloses a technique for editing a contents page which can be read easily and is excellent in operability even on a display with a small display region, such as a portable terminal. It is disclosed as the technique that document data on an electronic document are acquired, attributes required for creating the summary of contents are acquired for each of content items constituting the contents, arrangement order of the content items is determined according to a predetermined rearrangement rule, and attributes of the content items are changed based on a layout rule based on attributes related to a display device of a terminal.

Japanese Unexamined Patent Application Publication No. 2012-38286 discloses a technique for automatically or semiautomatically determining a display position and a display order of an electronic book. It is disclosed as a technique that anchor point information which is information on a stop position of a sight line and a movement order of the sight line that have been obtained according to the analysis result of content, a scenario indicating a stop time of the content for each anchor point and corresponding to a model, and reproduction content corresponding to the model, are transmitted to a terminal.

### SUMMARY OF THE INVENTION

However, in the systems disclosed in Japanese Unexamined Patent Application Publication No. 2012-141702 and Japanese Unexamined Patent Application Publication No. 2012-38286, in a case of generating an electronic magazine from a magazine which uses a lot of images, pictures, and illustrations with different sizes, there is a problem in that uniform enlargement or reduction cannot be performed, and visibility and operability cannot be ensured when the electronic magazine is viewed on a display such as a portable terminal with a small display region.

In addition, in the systems disclosed in Japanese Unexamined Patent Application Publication No. 2012-141702 and Japanese Unexamined Patent Application Publication No. 2012-38286, a process is performed in the unit of a single paper medium, and thus paper media cannot be edited, for example, in the unit of same theme.

Therefore, the present invention has been made in consideration of the above circumstances, and an object thereof is to provide an electronic magazine generation system, an electronic magazine generation method, and an electronic magazine generation program, capable of generating an electronic magazine in which visibility and operability are ensured even in a case where a magazine which uses a lot of images, pictures, and illustrations with different sizes is viewed on a display of a display apparatus such as a portable terminal or a digital home appliance with a small display region, and capable of generating an electronic magazine by editing a magazine which is a paper medium in the unit of themes.

According to an aspect of the present invention, there is provided an electronic magazine generation system which processes original information for creating a magazine which is a paper medium so as to generate an electronic magazine for being displayed on a display apparatus of a user, the system including an original information division recording unit that records a plurality of sorting information pieces into which each piece of original information for generating a plurality of magazines is divided in the unit of themes; an information extraction unit that extracts image information and text information included in each page of the sorting information in the unit of the pages; an image selection unit that analyzes information on a target object included in the image information and the text information so as to select image information which is important in at least one magazine which is a paper medium as a main image from an image information group which is a set of image information pieces having a same target object, and selects the other image information pieces included in the image information group as related images corresponding to the main image; a correspondence control unit that controls correspondence information obtained by correlating image information and text information related to the same target object with each other in the unit of the pages on the basis of the information on the target object analyzed by the image selection unit; a text string extraction unit that selects text information corresponding to the main image on the basis of the correspondence information, and extracts a headline text string from the selected text information; a background image recording unit that records a plurality of background images representing backgrounds of the sorting information; a main page creation unit that controls display sizes the main image and related image and font sizes of the text information and the text string as size information in accordance with a display region of the display apparatus, and creates a main page in which the main image and the text string are arranged on the background image on the basis of the controlled correspondence information; and a detailed information page creation unit that creates a detailed information page for displaying a related image of a selected main image and text information having correspondence information with the related image when the main image is selected by the user on the main page.

The electronic magazine generation system according to the aspect of the present invention may further include a target object information acquisition unit that acquires second image information indicating the target object related to the extracted image information or text information recorded in an external server, on the basis of the correspondence information, or acquires second text information indicating the target object related to the extracted image information or text information recorded in the external server, on the basis of the correspondence information. In addition, the correspondence control unit may control correspondence information to indicate a correspondence relationship with the second image information instead of the image information and/or the second text information instead of the text information, when the second image information or the second text information is acquired.

The “electronic magazine” refers to a digitalized publication. The electronic magazine may refer to digital content or content of a web page, which can be downloaded.

The “display apparatus” is an electronic apparatus having a function for displaying an electronic magazine. The display apparatus may be at least any one of a portable terminal, a client terminal, and a digital home appliance.

The “magazine which is a paper medium” refers to a publication produced on paper. The magazine may include a serial publication, a collection of photographs, and the like.

The “original information” refers to electronic data which is a basis for generating a paper medium such as a magazine or a collection of photographs. The original information may include text data which will become an original document or image information which will become an illustration.

The “theme” indicates a section of content of a paper medium such as a magazine or a collection of photographs. Specifically, the theme may indicate a chapter or a special feature.

The “sorting information” indicates original information which is divided in the unit of themes. The sorting information may include a plurality of pages.

The “original information division recording unit” records original information which is divided in a predetermined unit. The original information division recording unit may record original information which is divided in the unit of sorting information.

The “image information” indicates data on an image such as a picture or a painting. Specifically, the image information may indicate data on an image in which a target object such as a person or merchandise is drawn.

The “text information” indicates data on text such as a sentence or a headline text string included in the original information. For example, the text information may include descriptive text on image information.

The “information extraction unit” extracts predetermined information from sorting information. The information extraction unit may extract image information and text information from each page included in the sorting information.

The “image selection unit” analyzes image information so as to select a main image and a related image. For example, the image selection unit may analyze information on a target object included in image information and text information. In addition, a main image may be selected from among images including the same target object, and the other image information pieces may be selected as related images. For example, the image selection unit may treat a picture of a bag as a picture of the same target object from a picture of merchandise used in a magazine. At this time, the image selection unit may select a picture of bags of a brand A and a brand B which are treated to be important on a special feature page of the magazine as a main image, and may select pictures of remaining bags as related images.

The “target object” indicates a target described in image information or text information. In the previous example, the target object of the image information may be the bag. In addition, the target object in the text information may indicate a target described in the text information. Specifically, the target object may be merchandise, a model, a landscape, or the like.

The “correspondence control unit” controls a correspondence relationship between image information and text information related to the same target object. In addition, the correspondence control unit may rewrite correspondence information when the target object information acquisition unit acquires second image information or second text information. Specifically, a case where image information A and text information A regarding a target object A have a correspondence relationship will be described as an example. The correspondence information is rewritten and controlled so that second image information A and the text information A have a correspondence relationship when the second image information A is acquired from an external server in relation to the target object A.

The “correspondence information” indicates a correspondence relationship between image information and text information. Specifically, image information and text information including the same target object which is analyzed by the image selection unit are regarded to have a correspondence relationship, and are associated with each other by the correspondence information so as to be managed on a database. In addition, the correspondence information associates the image information (or the second image information) and the text information (or the second text information) with each other so as to create an electronic magazine through a combination thereof. For example, text information having a correspondence relationship with predetermined image information is displayed at the same position as the image information.

The “text string extraction unit” extracts a predetermined text string from text information. The text string extraction unit may extract a text string regarding a headline from the text information.

The “background image recording unit” records a background image. The background image recording unit may be a database.

The “background image” refers to data which is a background of an electronic magazine. The background image may indicate one which is created by citing a material of a background image of original data so as to be similar to a background of a paper medium for each page. The electronic magazine generation system may arrange image information or text information on the background image when generating an electronic magazine.

The “main page creation unit” creates a main page of an electronic magazine. The main page creation unit may create the main page by arranging a main image and a text string extracted from text information having correspondence information with the main image on a background image. In addition, the main page creation unit may optimize a size of the main image and a font size of the text string in accordance with a display region of the display apparatus so as to create the main page.

The “main page” is a page formed by an image which is treated as an important image in the magazine which is a paper medium. The main image and the text string for the main image may be displayed on the main page. In addition, the main image on the main page may include a link for transferring to the detailed information page.

The “detailed information page” is a page on which the related image is displayed. A user may display the detailed information page by selecting the main image on the main page.

The “detailed information page creation unit” creates a detailed information page. The detailed information page creation unit may create the detailed information page by using a related image and text information having correspondence information with the related image.

The “target object information acquisition unit” acquires information regarding a target object from an external server. The second image information and the second text information may be acquired from the external server.

The “external server” is an apparatus which is not included in the electronic magazine generation system according to the aspect of the present invention. The external server may be included in an electronic commerce (EC) site such as an Internet shopping site. In addition, image information regarding merchandise of the EC site may be recorded on the external server.

The “second image information” refers to an image regarding the same target object as the image information. The second image information may refer to an image in which a target object such as merchandise is drawn for a sales promotion. Specifically, the image information may refer to an image in which a background or the like is processed so as to highlight a target object.

The “second text information” is text information regarding the same target object as text information. The second text information may indicate advertisement text in which a target object such as merchandise is described for sales promotion.

In addition, the target object information acquisition unit may analyze information regarding image information included in text information so as to determine the external server of which an inquiry is to be made, and may further analyze an image similar to the image information so as to extract the second image information or the second text information. For example, a brand name of image information included in text information may be analyzed, so as to specify the EC site which deals in the brand and thus to make an inquiry thereof. At this time, candidate images of merchandise may be extracted from a feature of the image information.

The electronic magazine generation system according to the aspect of the present invention may further include an advertisement insertion unit that inserts advertisement information indicating an advertisement regarding the image information according to a predetermined rule.

The “advertisement insertion unit” inserts advertisement information into an electronic magazine. The advertisement information may be that regarding the image information or the second image information. The advertisement insertion unit inserts the advertisement information into the electronic magazine according to a predetermined rule.

The electronic magazine generation system may further include an accounting reception unit that receives accounting from a user in the unit of the sorting information.

The “accounting reception unit” accepts purchase of an electronic magazine from a user. The accounting reception unit may accept purchase of an electronic magazine in the unit of sorting information. For example, the accounting reception unit may present one page having sorting information to a user as a thumbnail, and the user may view the thumbnail and decide sorting information which is desired to be purchased.

The electronic magazine generation system according to the aspect of the present invention may further include a preference analysis unit that analyzes a preference of the user from information regarding viewing circumstances of an electronic magazine in the past of the user; and recommendation unit that recommends a page of an electronic magazine matching the preference of the user on the basis of an analysis result by the preference analysis unit.

The “preference analysis unit” analyzes a preference of a user. In addition, the preference analysis unit may analyze at least any one of viewing time, the number of times of viewing, and purchase history of an electronic magazine in the past of the user, as viewing circumstances. Specifically, viewing circumstances of blogs or web sites viewed by the user, or other electronic magazines, may be analyzed.

The “recommendation unit” recommends the electronic magazine to the user on the basis of an analysis result by the preference analysis unit. A similar electronic magazine may be recommended from an analysis result of viewing circumstances for other electronic magazines.

According to another aspect of the present invention, there is provided an electronic magazine generation method of processing original information for creating a magazine which is a paper medium so as to generate an electronic magazine for being displayed on a display apparatus of a user, the method including causing a computer to perform recording a plurality of sorting information pieces into which each piece of original information for generating a plurality of magazines is divided in the unit of themes; extracting image information and text information included in each page of the sorting information in the unit of the pages; analyzing information on a target object included in the image information and the text information so as to select image information which is important in at least one magazine which is a paper medium as a main image from an image information group which is a set of image information pieces having a same target object, and selecting the other image information pieces included in the image information group as related images corresponding to the main image; controlling correspondence information obtained by correlating image information and text information related to the same target object with each other in the unit of the pages on the basis of the information on the target object analyzed by the image selection unit; selecting text information corresponding to the main image on the basis of the correspondence information, and extracting a headline text string from the selected text information; recording a plurality of background images representing backgrounds of the sorting information; controlling display sizes of the main image and the related image and font sizes of the text information and the text string as size information in accordance with a display region of the display apparatus, and creating a main page in which the main image and the text string are arranged on the background image on the basis of the controlled correspondence information; and creating a detailed information page for displaying a related image of a selected main image and text information having correspondence information with the related image when the main image is selected by the user on the main page.

According to still another aspect of the present invention, there is provided an electronic magazine generation program for processing original information for creating a magazine which is a paper medium so as to generate an electronic magazine for being displayed on a display apparatus of a user, the program causing a computer to realize a function of recording a plurality of sorting information pieces into which each piece of original information for generating a plurality of magazines is divided in the unit of themes; a function of extracting image information and text information included in each page of the sorting information in the unit of the pages; a function of analyzing information on a target object included in the image information and the text information so as to select image information which is important in at least one magazine which is a paper medium as a main image from an image information group which is a set of image information pieces having a same target object, and selecting the other image information pieces included in the image information group as related images corresponding to the main image; a function of controlling correspondence information obtained by correlating image information and text information related to the same target object with each other in the unit of the pages on the basis of the information on the target object analyzed by the image selection unit; a function of selecting text information corresponding to the main image on the basis of the correspondence information, and extracting a headline text string from the selected text information; a function of recording a plurality of background images representing backgrounds of the sorting information; a function of controlling display sizes of the main image and the related image and font sizes of the text information and the text string as size information in accordance with a display region of the display apparatus, and creating a main page in which the main image and the text string are arranged on the background image on the basis of the controlled correspondence information; and a function of creating a detailed information page for displaying a related image of a selected main image and text information having correspondence information with the related image when the main image is selected by the user on the main page.

The electronic magazine generation system according to the aspects of the present invention includes the original information division recording unit which records a plurality of sorting information pieces into which each piece of original information for generating a plurality of magazines is divided in the unit of themes; the main page creation unit which controls display sizes of the main image and the related image and font sizes of the text information and the text string as size information in accordance with a display region of a display apparatus, and creates a main page in which the main image and the text string are arranged on a background image on the basis of the controlled correspondence information; and the detailed information page creation unit which creates a detailed information page for displaying a related image of a selected main image and text information having correspondence information with the related image when the main image is selected by the user on the main page. Therefore, it is possible to generate an electronic magazine in which visibility and operability are ensured even in a case where a magazine which uses a lot of images, pictures, and illustrations with different sizes is viewed on a display of the display apparatus such as a portable terminal or a digital home appliance with a small display region, and to generate an electronic magazine by editing a magazine which is a paper medium in the unit of themes.

In addition, the electronic magazine generation system according to the aspects of the present invention further includes the target object information acquisition unit which acquires second image information indicating a target object related to extracted image information or text information recorded in an external server, on the basis of correspondence information, or acquires second text information indicating a target object related to extracted image information or text information recorded in an external server, on the basis of correspondence information. The correspondence control unit controls correspondence information to indicate a correspondence relationship with second image information instead of image information and/or second text information instead of text information, when the second image information or the second text information is acquired. In a case where image information included in original information includes a marginal part or a region other than a target object, image information which does not include a marginal part or a region other than a target object can be acquired from an external server so as to be displayed for replacement. In addition, text information included in original information can be replaced with text information which has a higher sales promotion effect than information acquired from an external server.

In addition, since the electronic magazine generation system according to the aspects of the present invention includes the advertisement insertion unit which inserts advertisement information indicating an advertisement regarding image information or second image information according to a predetermined rule, it is possible to insert advertisement information in which a user has a deep interest and thus to increase an advertisement effect.

Since the electronic magazine generation system according to the aspects of the present invention includes the accounting reception unit which receives accounting from a user in the unit of sorting information, it is possible to accept purchase of an electronic magazine from a user in the unit of sorting information.

In addition, the electronic magazine generation system according to the aspects of the present invention further includes the preference analysis unit which analyzes a preference of a user from information regarding viewing circumstances of an electronic magazine in the past of the user, and the recommendation unit which recommends a page of an electronic magazine matching the preference of the user on the basis of an analysis result by the preference analysis unit. Therefore, it is possible to recommend an electronic magazine which satisfies a preference of the user in the unit of pages, from the viewing circumstances of the electronic magazines of the user.

In addition, the preference analysis unit analyzes at least any one of viewing time, the number of times of viewing, and purchase history of an electronic magazine in the past of the user, as information regarding viewing circumstances, and thus it is possible to analyze a preference of the user on the basis of the viewing time, the number of times of viewing, and the purchase history.

In addition, the target object information acquisition unit analyzes information regarding image information included in text information so as to determine an external server of which an inquiry is to be made, and further analyzes an image similar to the image information so as to extract candidates of second image information or second text information. Therefore, for example, the name such as a brand name of image information included in text information can be analyzed, so as to specify an external server (for example, an EC site or the like) which deals in the brand and thus to make an inquiry, and thus candidate images of merchandise can be extracted from a feature of the image information.

### BRIEF DESCRIPTION OF THE DRAWINGS

FIG. 1 is a block diagram of an electronic magazine generation system according to a first embodiment of the present invention.

FIG. 2 is a flowchart illustrating a process according to the first embodiment of the present invention.

FIGS. 3A and 3B are diagrams schematically illustrating a main page generated by the electronic magazine generation system according to the first embodiment of the present invention.

FIGS. 4A and 4B are image diagrams of an electronic magazine generated by the electronic magazine generation system according to the first embodiment of the present invention.

FIGS. 5A and 5B are diagrams schematically illustrating a detailed information page generated by the electronic magazine generation system according to the first embodiment of the present invention.

FIG. 6 is a diagram illustrating an outline of a process according to a second embodiment of the present invention.

FIG. 7 is a block diagram of an electronic magazine generation system according to the second embodiment of the present invention.

FIG. 8 is a flowchart illustrating a second image information acquisition process according to the second embodiment of the present invention.

FIG. 9 is a flowchart illustrating a process of inquiring of an external server according to the second embodiment of the present invention.

FIG. 10 is a flowchart illustrating a process performed by a preference analysis unit and a recommendation unit according to the second embodiment of the present invention.

FIG. 11 is a block diagram of an electronic magazine generation system according to a third embodiment of the present invention.

FIG. 12 is a flowchart illustrating a process performed by an advertisement insertion unit according to the third embodiment of the present invention.

### DETAILED DESCRIPTION OF THE INVENTION

### First Embodiment

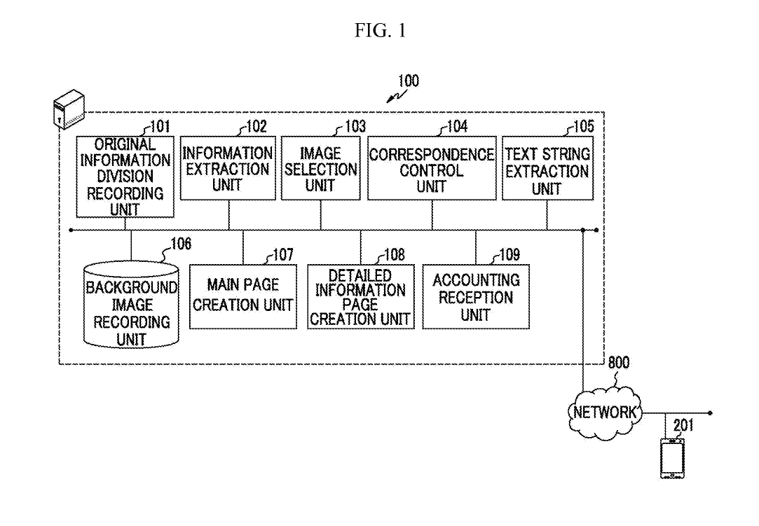

Hereinafter, a first embodiment of the present invention will be described with reference to FIGS. 1 to 5.

An electronic magazine generation system 100 according to the present embodiment includes an original information division recording unit 101 which records a plurality of sorting information pieces into which each piece of original information for generating a plurality of magazines is divided in the unit of themes; an information extraction unit 102 which extracts image information and text information included in each page of the sorting information in the unit of pages; an image selection unit 103 which analyzes information on a target object included in the image information and the text information so as to select image information which is important in at least one magazine which is a paper medium as a main image from an image information group which is a set of image information pieces having the same target object, and selects the other image information pieces included in the image information group as related images corresponding to the main image; a correspondence control unit 104 which controls correspondence information obtained by correlating image information and text information related to the same target object with each other in the unit of pages on the basis of the information on the target object analyzed by the image selection unit 103; a text string extraction unit 105 which selects text information corresponding to the main image on the basis of the correspondence information, and extracts a headline text string from the selected text information; a background image recording unit 106 which records a plurality of background images representing backgrounds of the sorting information; a main page creation unit 107 which controls display sizes of the main image and the related image and font sizes of the text information and the text string as size information in accordance with a display region of a display apparatus 201, and creates a main page in which the main image and the text string are arranged on a background image on the basis of the controlled correspondence information; and a detailed information page creation unit 108 which creates a detailed information page for displaying a related image of a selected main image and text information having correspondence information with the related image when the main image is selected by the user on the main page.

In addition, the electronic magazine generation system 100 may further include an accounting reception unit 109 which receives accounting from a user in the unit of sorting information.

The electronic magazine generation system 100 is provided with a computer or a server, and operates as various functional units by a CPU executing a program recorded on a RAM or a hard disk on the basis of various inputs. The program may be stored in a storage medium such as a CD-ROM or be distributed via a network 800 such as the Internet, so as to be installed in the computer.

The electronic magazine generation system 100 generates an electronic magazine from a plurality of existing magazines (paper media) so as to perform loose selling in the unit of themes. The theme indicates a section of content of a paper medium such as a magazine or a collection of photographs. Specifically, the theme indicates a chapter or a special feature.

When generating an electronic magazine from existing magazines, the system generating the electronic magazine generally uses original information. The original information is electronic data which is a basis for generating a paper medium such as a magazine or a collection of photographs. For example, the original information indicates text data which will become an original document or image data such as a picture.

Typically, a magazine is created in the A4 size. For this reason, in a case where content displayed on one page of a magazine which is a paper medium is displayed on a terminal with a small display region, such as the display apparatus 201 including a portable terminal or a digital home appliance, visibility cannot be ensured. Meanwhile, there are a lot of cases where related images are displayed on one page of a magazine, and thus there is a concern of impairing editing intention of an editor if the images are displayed one by one on different pages. For this reason, in the electronic magazine generation system 100, a main image which is an image important in the page is selected, only the main image and text information for explanation thereof are displayed on each page, and a related image is confirmed on a detailed information page by selecting the main image, thereby generating an electronic magazine with high visibility.

In the electronic magazine generation system 100, the above-described process is performed in the unit of special features of a magazine, and thus a created electronic magazine can be purchased in the unit of special features.

A function of each constituent element of the electronic magazine generation system 100 will be described with reference to FIG. 1. FIG. 1 is a block diagram of the electronic magazine generation system 100 according to the present embodiment.

The electronic magazine generation system 100 according to the present embodiment includes the original information division recording unit 101, the information extraction unit 102, the image selection unit 103, the correspondence control unit 104, the text string extraction unit 105, the background image recording unit 106, the main page creation unit 107, the detailed information page creation unit 108, and the accounting reception unit 109. In addition, the electronic magazine generation system 100 is connected to the display apparatus 201 via the wired or wireless network 800.

The display apparatus 201 is a mobile phone having a display with a touch panel function. The display apparatus 201 may also be a tablet PC, a PDA, or the like. In addition, the display apparatus 201 may be any one of a portable terminal, a client terminal, and a digital home appliance.

The original information division recording unit 101 records original information which is divided in a predetermined unit. The original information division recording unit 101 may record original information which is divided in the unit of sorting information.

The information extraction unit 102 extracts predetermined information from sorting information. The information extraction unit 102 may extract image information and text information from each page included in the sorting information.

The image selection unit 103 analyzes image information so as to select a main image and a related image. For example, the image selection unit 103 may analyze information on a target object included in image information and text information. In addition, a main image may be selected from among images including the same target object, and the other image information pieces may be selected as related images.

The correspondence control unit 104 controls a correspondence relationship between image information and text information related to the same target object.

The text string extraction unit 105 extracts a predetermined text string from text information. The text string extraction unit 105 may extract a text string regarding a headline from the text information.

The background image recording unit 106 records a background image. The background image recording unit 106 may be a database.

The main page creation unit 107 creates a main page of an electronic magazine. The main page creation unit 107 may create the main page by arranging a main image and a text string extracted from text information having correspondence information with the main image on a background image. In addition, the main page creation unit 107 may optimize a size of the main image and a font size of the text string in accordance with a display region of the display apparatus 201 so as to create the main image. Further, the main page creation unit 107 may appropriately convert font style information or color information on the text information and the text string.

The detailed information page creation unit 108 creates a detailed information page. The detailed information page creation unit 108 may create the detailed information page by using a related image and text information having correspondence information with the related image.

The accounting reception unit 109 accepts purchase of an electronic magazine from a user. The accounting reception unit 109 can accept purchase of an electronic magazine in the unit of sorting information. For example, the accounting reception unit 109 may present one page having sorting information to a user as a thumbnail, and the user may view the thumbnail and decide sorting information which is desired to be purchased.

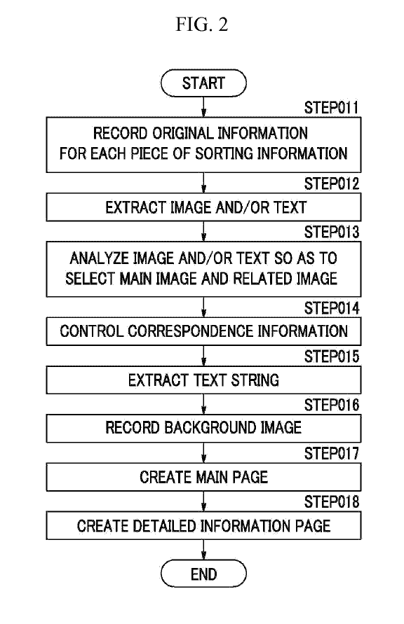

Next, a flow of a process performed by the electronic magazine generation system 100 will be described with reference to FIG. 2.

First, original information which is a basis of a plurality of magazines is given to the electronic magazine generation system 100. The original information may be received in the unit of magazines, and the original information on a plurality of magazines may be received as a single electronic data item.

The original information division recording unit 101 records sorting information pieces into which the received original information is divided in the unit of themes (STEP 011). Typically, a magazine is formed by a plurality of special features (themes). In the electronic magazine generation system 100, a magazine is purchased in the unit of themes, and thus the received original information is treated as sorting information pieces divided in the unit of themes and is recorded. The sorting information includes a plurality of pages.

Next, the information extraction unit 102 extracts image information and text information for each page included in the sorting information (STEP 012). The image information indicates data on an image such as a picture or a painting. Specifically, the image information may indicate data on an image in which a target object such as a person or merchandise is drawn. The text information indicates data on text such as a sentence or a headline text string included in the original information. For example, the text information may include descriptive text on image information.

The image selection unit 103 analyzes a target object included in the image information and the text information extracted by the information extraction unit 102 so as to select a main image and a related image (STEP 013). The target object indicates a target described in the image information or the text information. For example, in a case where the image information is a picture, the target object is a subject thereof. In addition, the target object in the text information may indicate a target described in the text information. Specifically, the target object may be merchandise, a model, a landscape, or the like.

For example, it is assumed that certain sorting information has a special feature on a bag. In this case, the image selection unit 103 treats a picture of a bag as a picture of the same target object as a picture of merchandise used in the magazine. At this time, the image selection unit 103 selects a picture of bags of a brand A and a brand B which are treated as important on a special feature page of the magazine as a main image, and selects pictures of remaining bags as related images.

Next, the correspondence control unit 104 controls correspondence information (STEP 014). The correspondence information indicates a correspondence relationship between image information and text information. Specifically, image information and text information including the same target object which is analyzed by the image selection unit 103 are regarded to have a correspondence relationship, and are associated with each other by the correspondence information so as to be managed on a database. In addition, the correspondence information associates the image information and the text information with each other so as to create an electronic magazine through a combination thereof. For example, text information having a correspondence relationship with predetermined image information is displayed at the same position as the image information.

The text string extraction unit 105 extracts a text string from the text information related to the main image by using the correspondence information controlled by the correspondence control unit 104 (STEP 015). This is because there is a possibility that, if all the text information is displayed on one page, text cannot be confirmed on the display apparatus 201 with a small display region. For this reason, the text string extraction unit 105 extracts a text string which is a headline from the text information so as to be displayed along with the main image.

Next, the background image recording unit 106 records a background image (STEP 016). The background image refers to data which is a background of an electronic magazine. The background image is designed to be similar to a background of a paper medium for each page. For example, an optimal background may be determined from background images which are registered in the electronic magazine generation system 100 in advance, and may be held so as to be forwarded to a subsequent process. In addition, the background image may be created by the background image recording unit 106 from an image which is used as a background in sorting information, and may be held so as to be forwarded to a subsequent process.

In addition, the main page creation unit 107 creates a main page of an electronic magazine (STEP 017). The main page creation unit 107 arranges the main image and the text string extracted from the text information having the correspondence information with the main image on the background image, so as to create a main page. At this time, the main page creation unit 107 optimizes a size of the main image and a font size of the text string in accordance with the display region of the display apparatus 201, and then creates the main page. In addition, at this time, the main page creation unit 107 may appropriately convert style information or color information in relation to fonts of the text information and text string.

The main page is a page formed by an image which is treated as an important image in the magazine which is a paper medium. The main image and the text string for the main image are displayed on the main page. In addition, the main image on the main page includes a link for transferring to the detailed information page.

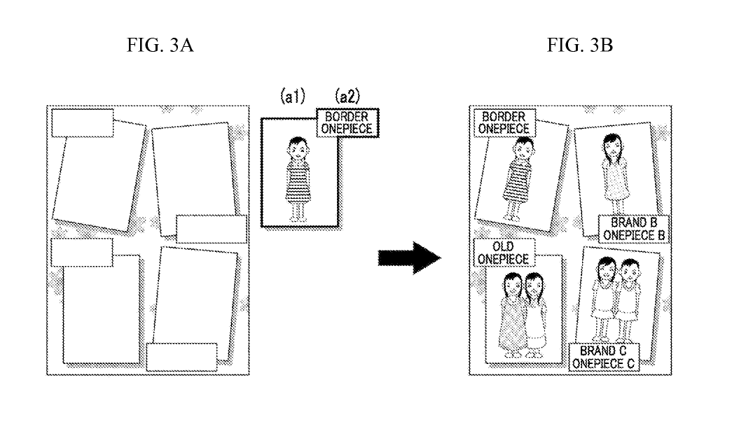

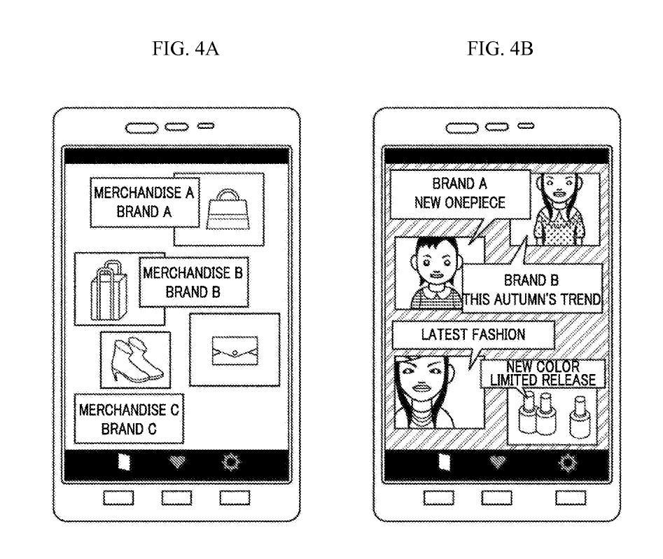

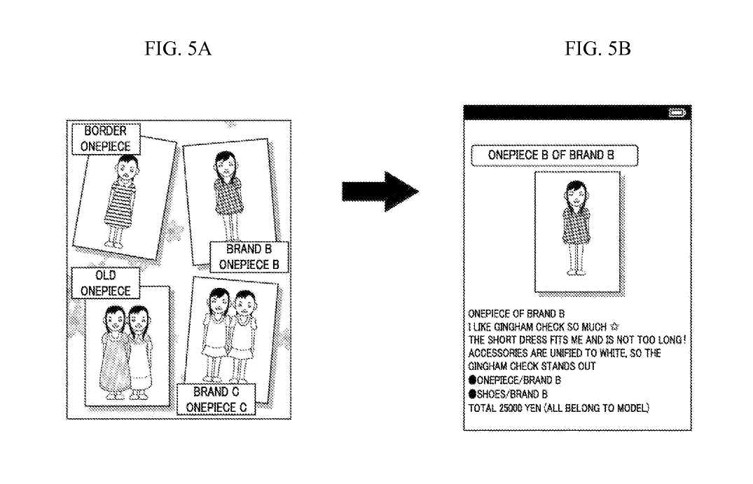

FIGS. 3A and 3B are diagrams schematically illustrating a state in which the main page created by the main page creation unit 107 is displayed on the display apparatus 201. FIG. 3A illustrates a background image recorded in the background image recording unit 106. In addition, (a1) and (a2) in FIG. 3 respectively illustrate image information and text information having a correspondence relationship. The main page creation unit 107 arranges the image information and the text information on the background image on the basis of the correspondence information, so as to create an electronic magazine as illustrated in FIG. 3B. FIGS. 4A and 4B illustrate examples of the electronic magazine created by the main page creation unit 107.

Next, the detailed information page creation unit 108 creates a detailed information page (STEP 018). The detailed information page creation unit 108 creates the detailed information page by using a related image and text information having correspondence information with the related image. The detailed information page is a page on which the related image is displayed. A user may display the detailed information page by selecting the main image on the main page.

FIG. 5B is a diagram schematically illustrating a state in which the electronic magazine created in the present embodiment is displayed on the display apparatus 201. FIG. 5B is displayed from the main page illustrated in FIG. 5A by a user touching a main image whose details are desired to be viewed. If the user touches the main image from the display of the display apparatus 201, a related image of the main image and the full text of text information are displayed.

### Second Embodiment

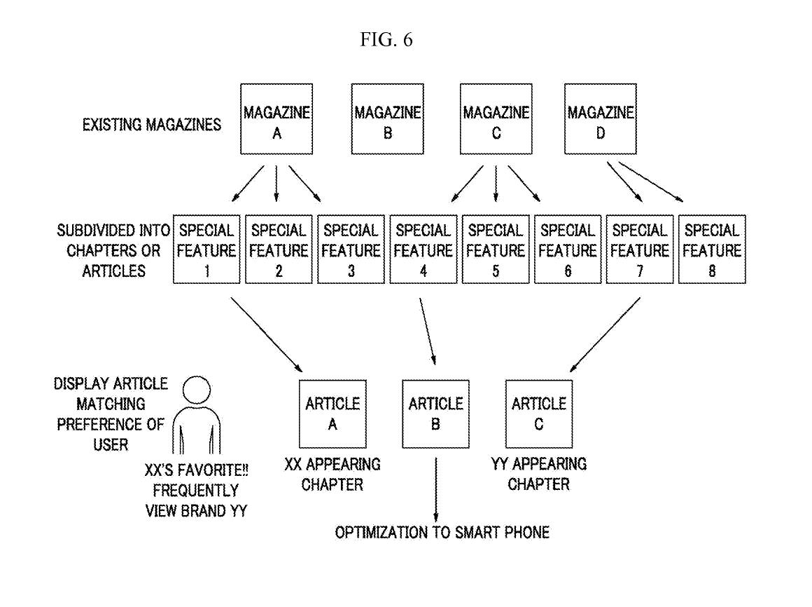

Hereinafter, a second embodiment of the present invention will be described with reference to FIGS. 6 to 8.

An electronic magazine generation system 100 according to the present embodiment includes an original information division recording unit 101 which records a plurality of sorting information pieces into which each piece of original information for generating a plurality of magazines is divided in the unit of themes; an information extraction unit 102 which extracts image information and text information included in each page of the sorting information in the unit of pages; an image selection unit 103 which analyzes information on a target object included in the image information and the text information so as to select image information which is important in at least one magazine which is a paper medium as a main image from an image information group which is a set of image information pieces having the same target object, and selects the other image information pieces included in the image information group as related images corresponding to the main image; a correspondence control unit 104 which controls correspondence information obtained by correlating image information and text information related to the same target object with each other in the unit of pages on the basis of the information on the target object analyzed by the image selection unit 103; a text string extraction unit 105 which selects text information corresponding to the main image on the basis of the correspondence information, and extracts a headline text string from the selected text information; a background image recording unit 106 which records a plurality of background images representing backgrounds of the sorting information; a main page creation unit 107 which controls display sizes of the main image and the related image and font sizes of the text information and the text string as size information in accordance with a display region of a display apparatus 201, and creates a main page in which the main image and the text string are arranged on a background image on the basis of the controlled correspondence information; and a detailed information page creation unit 108 which creates a detailed information page for displaying a related image of a selected main image and text information having correspondence information with the related image when the main image is selected by the user on the main page.

In addition, the electronic magazine generation system 100 may further include a target object information acquisition unit 117 which acquires second image information indicating a target object related to extracted image information or text information recorded in an external server, on the basis of correspondence information, or acquires second text information indicating a target object related to extracted image information or text information recorded in an external server, on the basis of correspondence information. The correspondence control unit 104 may control correspondence information to indicate a correspondence relationship with second image information instead of image information and/or second text information instead of text information, when the second image information or the second text information is acquired.

In addition, the target object information acquisition unit 117 may analyze information regarding image information included in text information so as to determine an external server of which an inquiry is to be made, and may further analyze an image similar to the image information so as to extract second image information or second text information. For example, a brand name of image information included in text information may be analyzed, so as to specify an EC site which deals in the brand and thus to make an inquiry. At this time, candidate images of merchandise may be extracted from a feature of the image information.

In addition, the electronic magazine generation system 100 may further include a preference analysis unit 118 which analyzes a preference of a user from information regarding viewing circumstances of an electronic magazine in the past of the user, and a recommendation unit 119 which recommends a page of an electronic magazine matching the preference of the user on the basis of an analysis result by the preference analysis unit 118.

FIG. 6 is a chart illustrating an outline of a process performed by the electronic magazine generation system 100 according to the present embodiment.

The electronic magazine generation system 100 generates an electronic magazine from electronic data on a plurality of magazines which are paper media so as to perform loose selling in the unit of special features. The generated electronic magazine in the unit of special features is recommended so as to match a preference of a user in the unit of pages.

When generating an electronic magazine from existing magazines, the system generating the electronic magazine generally uses original information. The original information is electronic data which is a basis for generating a paper medium such as a magazine or a collection of photographs. For example, the original information indicates text data which will become an original document or image data such as a picture.

There are cases where original information such as image data for creating a paper medium includes a marginal part (a non-print region) in which printing is not performed or a region (a region which is used in a paper medium) when the original information is processed so as to be printed as a paper medium. Particularly, in a case of the publishing industry of a magazine and the like, original information (especially an image) is processed so as to be used. For this reason, if such original information is used without processing, there is a problem in that a marginal part or a region other than a target object is displayed in a state of being included. Therefore, the electronic magazine generation system 100 inquires of an external server 301, an external server 302, or an external server 303 about an image including a marginal part or a region other than a target object which is improperly displayed without processing as an electronic magazine, so as to perform an exchange process. Accordingly, when generating an electronic magazine, it is possible to use an image which does not include an improper background.

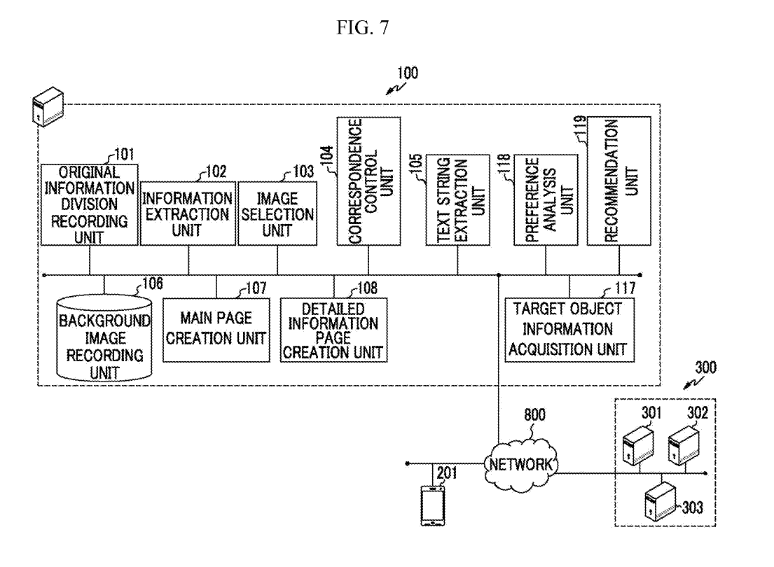

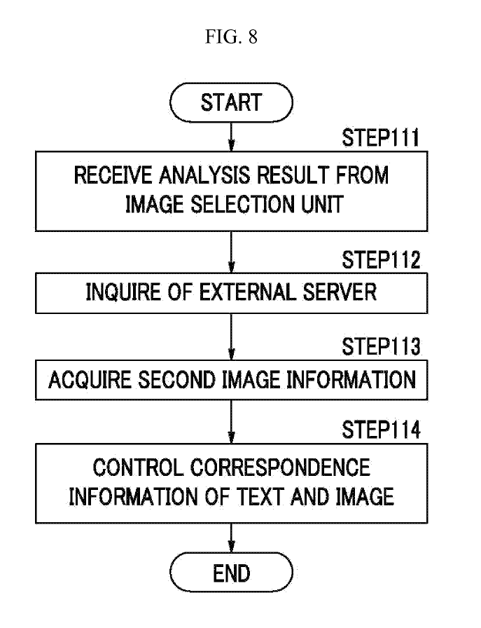

Next, a function of each constituent element of the electronic magazine generation system 100 will be described with reference to FIG. 7. FIG. 7 is a block diagram illustrating the electronic magazine generation system 100 of the present embodiment, the external server 301, the external server 302, and the external server 303.

The electronic magazine generation system 100 according to the present embodiment includes the original information division recording unit 101, the information extraction unit 102, the image selection unit 103, the correspondence control unit 104, the text string extraction unit 105, the background image recording unit 106, the main page creation unit 107, the detailed information page creation unit 108, the target object information acquisition unit 117, the preference analysis unit 118, and the recommendation unit 119. In addition, the electronic magazine generation system 100 is connected to the EC site 300 via the wired or wireless network 800. The EC site 300 includes the external server 301, the external server 302, and the external server 303.

The target object information acquisition unit 117 acquires information regarding a target object from the external server 301, the external server 302, or the external server 303. The second image information and the second text information may be acquired from the external server 301, the external server 302, or the external server 303.

In addition, the target object information acquisition unit 117 may analyze information regarding image information included in text information so as to determine the external server 301, the external server 302, or the external server 303 of which an inquiry is to be made, and may further analyze an image similar to the image information so as to extract the second image information or the second text information. For example, a brand name of image information included in text information may be analyzed, so as to specify the EC site 300 which deals in the brand and thus to make an inquiry. At this time, candidate images of merchandise may be extracted from a feature of the image information.

The external server 301, the external server 302, or the external server 303 is an apparatus which is not included in the electronic magazine generation system 100. In the present embodiment, the external server 301, the external server 302, or the external server 303 is included in an EC site such as an Internet shopping site. Image information regarding merchandise of the EC site 300 is recorded on the external server 301, the external server 302, or the external server 303.

The second image information refers to an image regarding the same target object as the image information. The image information may refer to an image in which a target object such as merchandise is drawn for sales promotion. In the present embodiment, the image information refers to an image in which a background or the like is processed so as to highlight a target object for sales promotion.

The second text information is text information regarding the same target object as text information. In the present embodiment, the second text information indicates an advertisement text in which a target object such as merchandise is described for sales promotion.

The correspondence information indicates a correspondence relationship between image information and text information. The image information (or the second image information) and the text information (or the second text information) having the correspondence information may be combined and associated with each other so as to create an electronic magazine. Specifically, text information having a correspondence relationship with predetermined image information is displayed at the same position as the image information.

The correspondence control unit 104 rewrites and controls the correspondence information. The correspondence control unit 104 may rewrite the correspondence information when the target object information acquisition unit 117 acquires the second image information or the second text information. Specifically, a case where image information A and text information A regarding a target object A have a correspondence relationship will be described as an example. The correspondence control unit 104 rewrites and controls the correspondence information so that second image information A and the text information A have a correspondence relationship when the second image information A is acquired from the external server 301, the external server 302, or the external server 303 in relation to the target object A.

The preference analysis unit 118 analyzes a preference of a user. In addition, the preference analysis unit 118 may analyze at least one of viewing time, the number of times of viewing, and purchase history of an electronic magazine in the past of the user, as viewing circumstances. Specifically, viewing circumstances of blogs or web sites viewed by the user, or other electronic magazines, are analyzed, and the electronic magazines are scored in accordance with the viewing circumstances. For example, a high score is given to an electronic magazine whose viewing time is long or an electronic magazine whose number of times of viewing is large, and, in contrast, a low score is given to an electronic magazine whose viewing time is short or an electronic magazine whose number of times of viewing is small. In addition, a score may be given from purchase history of merchandise of the user on the EC site 300. In this case, a score which is higher than a score given on the basis of the viewing time may be given.

The recommendation unit 119 recommends the electronic magazine to the user on the basis of an analysis result by the preference analysis unit 118. A similar electronic magazine may be recommended from an analysis result of viewing circumstances for other electronic magazines. For example, in a case where a user frequently reads an electronic magazine A related to a women's fashion magazine for people in their twenties, the recommendation unit 119 recommends an electronic magazine B which is another women's magazine for the same generation and deals with the same brand as the electronic magazine A.

Next, a flow of a cooperative process with an external server in the present embodiment will be described with reference to FIG. 8.

First, the target object information acquisition unit 117 receives an analysis result from the image selection unit 103 (STEP 111). The analysis result is a result of analyzing a target object of text information. Specifically, the target object information acquisition unit 117 receives a result of analyzing a merchandise name, a brand name, a model name, its abbreviated name, or the like, included in the text information. This analysis may be performed by the electronic magazine generation system 100, or may be performed by a user.

Next, the target object information acquisition unit 117 inquires of the external server on the basis of the analysis result (STEP 112). At this time, the target object information acquisition unit 117 inquires of the external server so as to acquire a second image of image information corresponding to the text information related to the received analysis result, by using correspondence information. For example, a description will be made in a case where text information 1 and image information 1 have a correspondence relationship, and a target object of the text information 1 is an abbreviated name of a brand A or a merchandise name of the brand A. It is assumed that the external server 301, the external server 302, and the external server 303 are EC sites which respectively deal in the brand A, a brand B, and a brand C. In this case, the target object information acquisition unit 117 inquires of the external server 301 so as to acquire a second target object image for the image information 1 from the external server 301 (STEP 113).

The correspondence control unit 104 controls the correspondence information of the text information 1 and the image information 1 to indicate a correspondence relationship between the text information 1 and the second image information (STEP 114).

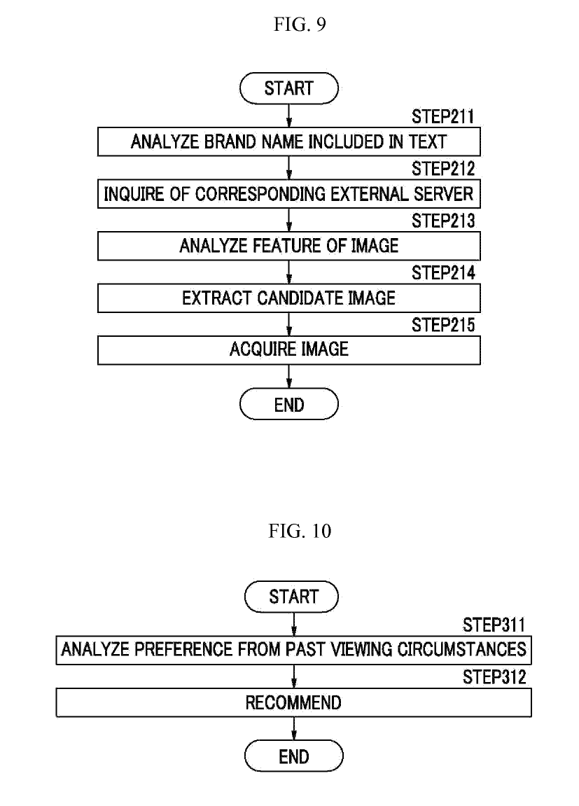

Here, a process performed by the target object information acquisition unit 117 will be described in detail with reference to FIG. 9. FIG. 9 is a flowchart illustrating a process performed by the target object information acquisition unit 117 in the present embodiment.

Here, a description will be made of a process of acquiring second image information 1 of image information having a correspondence relationship with image information A. First, the target object information acquisition unit 117 analyzes a brand name included in the text information A (STEP 211). For example, merchandise with the analyzed brand name is assumed to be dealt in by the external server 301 among the EC sites 300 which cooperate with the present system. In this case, the target object information acquisition unit 117 selects the external server 301 among the external server 301, the external server 302, and the external server 303, and inquires thereof (STEP 212). Further, the target object information acquisition unit 117 analyzes a feature of the image information 1 having a correspondence relationship with the text information A on the basis of the correspondence information (STEP 213), and extracts candidate images of second image information from the external server 301 (STEP 214). A manager of the EC site 300 selects the second image information 1 from the extracted candidate images, and the target object information acquisition unit 117 acquires the selected second image information 1 (STEP 215). At this time, second text information A associated with the second image information 1 may also be acquired on the external server 301. In this case, the correspondence control unit 104 controls the correspondence information of the image information 1 and the text information A to indicate a correspondence relationship between the second image information 1 and the second text information A.

Next, a description will be made of a flowchart of a process performed by the preference analysis unit 118 and the recommendation unit 119 with reference to FIG. 10. FIG. 10 is a flowchart illustrating a flow of a recommendation process in the present embodiment.

The preference analysis unit 118 analyzes a preference of a user from purchase history of electronic magazines of the user hitherto or viewing circumstances of blogs or home pages (STEP 311). Specifically, scores are given in accordance with the viewing circumstances for each of merchandise, brands, and models posted on the blogs or the home pages. For example, in a case where the user views blogs and home pages posting an article on the brand A for a total of five hours during three days, fifteen points may be given to the brand A. At this time, a score is given to a page of another electronic magazine which posts a special feature on the brand A, and the page is recommended by the recommendation unit 119 if a predetermined threshold value is exceeded (STEP 312).

Other functions and configurations are the same as in the first embodiment.

### Third Embodiment

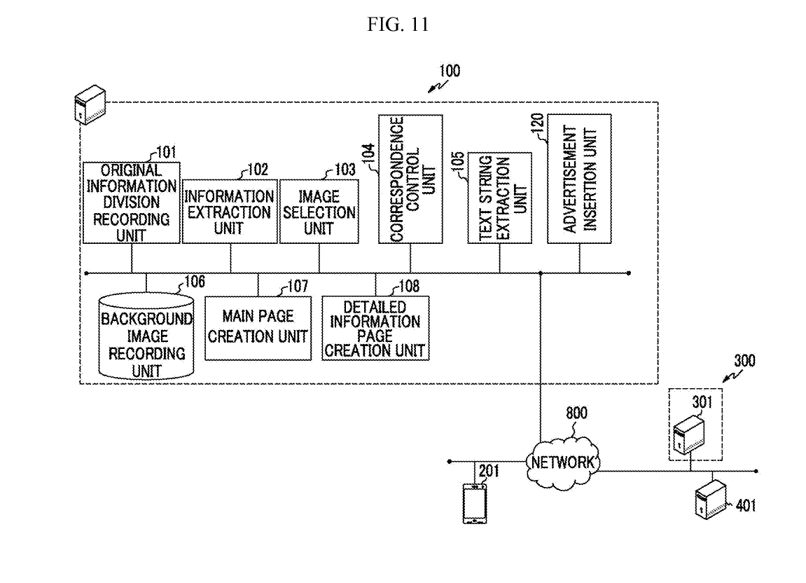

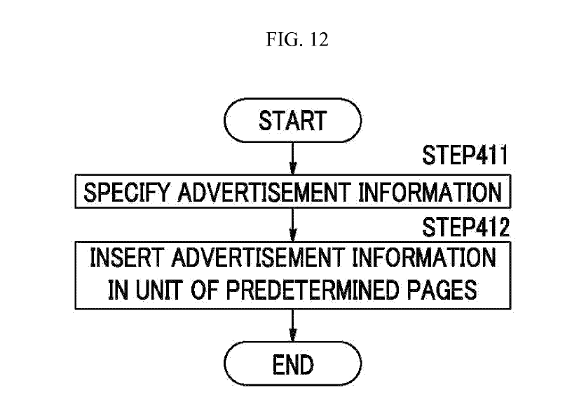

Hereinafter, a third embodiment of the present invention will be described with reference to FIGS. 11 and 12.

An electronic magazine generation system 100 according to the present embodiment includes an original information division recording unit 101 which records a plurality of sorting information pieces into which each piece of original information for generating a plurality of magazines is divided in the unit of themes; an information extraction unit 102 which extracts image information and text information included in each page of the sorting information in the unit of pages; an image selection unit 103 which analyzes information on a target object included in the image information and the text information so as to select image information which is important in at least one magazine which is a paper medium as a main image from an image information group which is a set of image information pieces having the same target object, and selects the other image information pieces included in the image information group as related images corresponding to the main image; a correspondence control unit 104 which controls correspondence information obtained by correlating image information and text information related to the same target object with each other in the unit of pages on the basis of the information on the target object analyzed by the image selection unit 103; a text string extraction unit 105 which selects text information corresponding to the main image on the basis of the correspondence information, and extracts a headline text string from the selected text information; a background image recording unit 106 which records a plurality of background images representing backgrounds of the sorting information; a main page creation unit 107 which controls display sizes of the main image and the related image and font sizes of the text information and the text string as size information in accordance with a display region of a display apparatus 201, and creates a main page in which the main image and the text string are arranged on a background image on the basis of the controlled correspondence information; and a detailed information page creation unit 108 which creates a detailed information page for displaying a related image of a selected main image and text information having correspondence information with the related image when the main image is selected by the user on the main page.

In addition, the electronic magazine generation system 100 may further include an advertisement insertion unit 120 which inserts advertisement information indicating an advertisement regarding image information according to a predetermined rule.

A function of each constituent element of the electronic magazine generation system 100 will be described with reference to FIG. 11. FIG. 11 is a block diagram illustrating the electronic magazine generation system 100 of the present embodiment, and the external server 301.

The electronic magazine generation system 100 according to the present embodiment includes the original information division recording unit 101, the information extraction unit 102, the image selection unit 103, the correspondence control unit 104, the text string extraction unit 105, the background image recording unit 106, the main page creation unit 107, the detailed information page creation unit 108, and the advertisement insertion unit 120. In addition, the electronic magazine generation system 100 is connected to the EC site 300 and an external server 401 via the wired or wireless network 800. The EC site 300 includes the external server 301.

The external server 401 is a server which belongs to a publishing or newspaper office. Original information is recorded in a format such as electronic publication (EPUB) on the external server 401. The original information division recording unit 101 receives the original information from the external server 401 and records the original information in the unit of sorting information.

The advertisement insertion unit 120 inserts advertisement information into an electronic magazine. Specifically, the advertisement insertion unit 120 receives an image for merchandise sales promotion, preserved on the EC site 300, as the advertisement information, and inserts the image. The advertisement information may be one regarding image information or second image information. The advertisement insertion unit 120 inserts the advertisement information into the electronic magazine according to a predetermined rule. In the present embodiment, the advertisement insertion unit 120 inserts an advertisement regarding the same merchandise as a target object recorded in the image information or the second image information.

With reference to FIG. 12, a description will be made of a flow of a process performed by the advertisement insertion unit 120 in the present embodiment. The advertisement insertion unit 120 specifies advertisement information to be inserted from image information or second image information (STEP 411). The advertisement information to be inserted at this time may be one regarding the image information or the second image information. For example, in a case where a target object of the image information is a bag of the brand A, advertisement information regarding related merchandise of the brand A or advertisement information regarding bags of other brands may be inserted. The advertisement insertion unit 120 inserts the specified advertisement information in the unit of predetermined pages (STEP 412). The advertisement information may be inserted immediately before or immediately after a page posting the image information or the like related to the advertisement information. Accordingly, a user views advertisement information related to an electronic magazine of a theme purchased by the user, and thus it is possible to increase an advertisement effect.

Other functions and configurations are the same as in the first embodiment.

As mentioned above, although the embodiments of the present invention have been described, the present invention is not limited to the embodiments of the technique, and may have various modifications and alterations on the basis of the technical spirit of the present invention. For example, in the first to third embodiments of the present invention, the electronic magazine generation system 100 converts a magazine which is a paper medium into an electronic magazine. However, a processing target of the present invention is not limited to a magazine, and may generate an electronic magazine from a publication which is produced on paper, such as a serial publication or a collection of photographs.

The electronic magazine generation system 100 includes the original information division recording unit 101 which records a plurality of sorting information pieces into which each piece of original information for generating a plurality of magazines is divided in the unit of themes; the main page creation unit 107 which controls display sizes of the main image and the related image and font sizes of the text information and the text string as size information in accordance with a display region of a display apparatus 201, and creates a main page in which the main image and the text string are arranged on a background image on the basis of the controlled correspondence information; and the detailed information page creation unit 108 which creates a detailed information page for displaying a related image of a selected main image and text information having correspondence information with the related image when the main image is selected by the user on the main page. Therefore, it is possible to generate an electronic magazine in which visibility and operability are ensured even in a case where a magazine which uses a lot of images, pictures, and illustrations with different sizes is viewed on a display of the display apparatus 201 such as a portable terminal or a digital home appliance with a small display region, and to generate an electronic magazine by editing a magazine which is a paper medium in the unit of themes.

In addition, the electronic magazine generation system 100 further includes the target object information acquisition unit 117 which acquires second image information indicating a target object related to extracted image information or text information recorded in an external server, on the basis of correspondence information, or acquires second text information indicating a target object related to extracted image information or text information recorded in an external server, on the basis of correspondence information. The correspondence control unit 104 controls correspondence information to indicate a correspondence relationship with second image information instead of image information and/or second text information instead of text information, when the second image information or the second text information is acquired. In a case where image information included in original information includes a marginal part or a region other than a target object, image information which does not include a marginal part or a region other than a target object can be acquired from an external server so as to be displayed for replacement. In addition, text information included in original information can be replaced with text information which has a higher sales promotion effect than information acquired from an external server.

In addition, since the electronic magazine generation system 100 further includes the advertisement insertion unit 120 which inserts advertisement information indicating an advertisement regarding image information or second image information according to a predetermined rule, it is possible to insert advertisement information in which a user has a deep interest and thus to increase an advertisement effect.

Since the electronic magazine generation system 100 includes an accounting reception unit 109 which receives accounting from a user in the unit of sorting information, it is possible to accept purchase of an electronic magazine from a user in the unit of sorting information.

In addition, the electronic magazine generation system 100 further includes the preference analysis unit 118 which analyzes a preference of a user from information regarding viewing circumstances of an electronic magazine in the past of the user, and the recommendation unit 119 which recommends a page of an electronic magazine matching the preference of the user on the basis of an analysis result by the preference analysis unit 118. Therefore, it is possible to recommend an electronic magazine which satisfies a preference of the user in the unit of pages, from the viewing circumstances of the electronic magazines of the user.

In addition, the preference analysis unit 118 analyzes at least one of viewing time, the number of times of viewing, and purchase history of an electronic magazine in the past of the user, as viewing circumstances, and thus it is possible to analyze a preference of the user on the basis of the viewing time, the number of times of viewing, and the purchase history.

In addition, the target object information acquisition unit 117 analyzes information regarding image information included in text information so as to determine an external server of which an inquiry is to be made, and further analyzes an image similar to the image information so as to extract candidates of second image information or second text information. Therefore, for example, the name such as a brand name of image information included in text information can be analyzed, so as to specify an external server (for example, an EC site or the like) which deals in the brand and thus to make an inquiry, and thus candidate images of merchandise can be extracted from a feature of the image information.

1. An electronic magazine generation system which processes original information for creating a magazine which is a paper medium so as to generate an electronic magazine for being displayed on a display apparatus of a user, the system comprising:
an original information division recording unit that records a plurality of sorting information pieces into which each piece of original information for generating a plurality of magazines is divided in the unit of themes;
an information extraction unit that extracts image information and text information included in each page of the sorting information in the unit of the pages;
an image selection unit that analyzes information on a target object included in the image information and the text information so as to select image information which is important in at least one magazine which is a paper medium as a main image from an image information group which is a set of image information pieces having a same target object, and selects the other image information pieces included in the image information group as related images corresponding to the main image;
a correspondence control unit that controls correspondence information obtained by correlating image information and text information related to the same target object with each other in the unit of the pages on the basis of the information on the target object analyzed by the image selection unit;
a text string extraction unit that selects text information corresponding to the main image on the basis of the correspondence information, and extracts a headline text string from the selected text information;
a background image recording unit that records a plurality of background images representing backgrounds of the sorting information;
a main page creation unit that controls display sizes of the main image and the related image and font sizes of the text information and the text string as size information in accordance with a display region of the display apparatus, and creates a main page in which the main image and the text string are arranged on the background image on the basis of the controlled correspondence information; and
a detailed information page creation unit that creates a detailed information page for displaying a related image of a selected main image and text information having correspondence information with the related image when the main image is selected by the user on the main page.

2. The electronic magazine generation system according to claim 1,
wherein the display apparatus is any one of a portable terminal, a client terminal, and a digital home appliance.

3. The electronic magazine generation system according to claim 1, further comprising:
a target object information acquisition unit that acquires second image information indicating the target object related to the extracted image information or text information recorded in an external server, on the basis of the correspondence information, or acquires second text information indicating the target object related to the extracted image information or text information recorded in the external server, on the basis of the correspondence information,
wherein the correspondence control unit controls correspondence information to indicate a correspondence relationship with the second image information instead of the image information and/or the second text information instead of the text information, when the second image information or the second text information is acquired.

4. The electronic magazine generation system according to claim 1, further comprising:
an advertisement insertion unit that inserts advertisement information indicating an advertisement regarding the image information or the second image information according to a predetermined rule.

5. The electronic magazine generation system according to claim 1, further comprising:
an accounting reception unit that receives accounting from a user in the unit of the sorting information.

6. The electronic magazine generation system according to claim 1, further comprising:
a preference analysis unit that analyzes a preference of the user from information regarding viewing circumstances of an electronic magazine in the past of the user; and
recommendation unit that recommends a page of an electronic magazine matching the preference of the user on the basis of an analysis result by the preference analysis unit.

7. The electronic magazine generation system according to claim 6,
wherein the preference analysis unit analyzes at least one of viewing time, the number of times of viewing, and purchase history of an electronic magazine in the past of the user, as information regarding viewing circumstances.

8. The electronic magazine generation system according to claim 1,
wherein the target object information acquisition unit analyzes information regarding image information included in the text information so as to determine an external server of which an inquiry is to be made, and further analyzes image information including a target object similar to a target object included in the image information so as to extract candidates of second image information or second text information.

9. An electronic magazine generation method of processing original information for creating a magazine which is a paper medium so as to generate an electronic magazine for being displayed on a display apparatus of a user, the method comprising:
causing a computer to perform:
recording a plurality of sorting information pieces into which each piece of original information for generating a plurality of magazines is divided in the unit of themes;
extracting image information and text information included in each page of the sorting information in the unit of the pages;
analyzing information on a target object included in the image information and the text information so as to select image information which is important in at least one magazine which is a paper medium as a main image from an image information group which is a set of image information pieces having a same target object, and selecting the other image information pieces included in the image information group as related images corresponding to the main image;
controlling correspondence information obtained by correlating image information and text information related to the same target object with each other in the unit of the pages on the basis of the information on the target object analyzed by the image selection unit;
selecting text information corresponding to the main image on the basis of the correspondence information, and extracting a headline text string from the selected text information;
recording a plurality of background images representing backgrounds of the sorting information;
controlling display sizes of the main image and the related image and font sizes of the text information and the text string as size information in accordance with a display region of the display apparatus, and creating a main page in which the main image and the text string are arranged on the background image on the basis of the controlled correspondence information; and
creating a detailed information page for displaying a related image of a selected main image and text information having correspondence information with the related image when the main image is selected by the user on the main page.

10. A computer readable recording medium recording thereon an electronic magazine generation program for processing original information for creating a magazine which is a paper medium so as to generate an electronic magazine for being displayed on a display apparatus of a user, the program causing the computer to realize:
a function of recording a plurality of sorting information pieces into which each piece of original information for generating a plurality of magazines is divided in the unit of themes;
a function of extracting image information and text information included in each page of the sorting information in the unit of the pages;
a function of analyzing information on a target object included in the image information and the text information so as to select image information which is important in at least one magazine which is a paper medium as a main image from an image information group which is a set of image information pieces having a same target object, and selecting the other image information pieces included in the image information group as related images corresponding to the main image;
a function of controlling correspondence information obtained by correlating image information and text information related to the same target object with each other in the unit of the pages on the basis of the information on the target object analyzed by the image selection unit;
a function of selecting text information corresponding to the main image on the basis of the correspondence information, and extracting a headline text string from the selected text information;
a function of recording a plurality of background images representing backgrounds of the sorting information;
a function of controlling display sizes of the main image and the related image and font sizes of the text information and the text string as size information in accordance with a display region of the display apparatus, and creating a main page in which the main image and the text string are arranged on the background image on the basis of the controlled correspondence information; and
a function of creating a detailed information page for displaying a related image of a selected main image and text information having correspondence information with the related image when the main image is selected by the user on the main page.
